(19) United States
(12) Patent Application Publication
(10) Pub. No.: US 2025/0236565 A1
(43) Pub. Date: Jul. 24, 2025

(54) POROUS CERAMIC BODY, METHOD FOR PREPARING POROUS CERAMIC BODY, HEATING COMPONENT, ATOMIZER, AND ELECTRONIC ATOMIZATION DEVICE

(71) Applicant: SHENZHEN SMOORE TECHNOLOGY LIMITED, Shenzhen (CN)

(72) Inventors: Jianguo WANG, Manassas, VA (US); Zhiqiang SHI, Shenzhen (CN); Lingrong XIAO, Shenzhen (CN); Changyong YI, Shenzhen (CN); Congwen XIAO, Shenzhen (CN); Heng ZHANG, Shenzhen (CN); Qiang LI, Shenzhen (CN); Xueqin HE, Shenzhen (CN); Huitao ZENG, Shenzhen (CN)

(21) Appl. No.: 19/171,786

(22) Filed: Apr. 7, 2025

Related U.S. Application Data
(63) Continuation of application No. PCT/CN2023/121906, filed on Sep. 27, 2023.

(30) Foreign Application Priority Data
Oct. 8, 2022 (CN) 202211221391.0

(51) Int. Cl. C04B 38/00; C04B 35/195; C04B 41/00

(52) U.S. Cl. CPC C04B 38/0054; C04B 35/195; C04B 38/0074; C04B 41/0072; C04B 2235/3222; C04B 2235/3418; C04B 2235/3445; C04B 2235/3472; C04B 2235/3481; C04B 2235/96

(57) ABSTRACT

In a porous ceramic body, a pore size distribution of the porous ceramic body conforms to: d₅₀ is about 5 μm to about 50 μm, and β is about 0.17 to about 0.55. β=(d₅₀−d₁₀)/d₅₀. In an embodiment, wherein the porous ceramic body includes at least one of quartz and cordierite.

### CROSS-REFERENCE TO PRIOR APPLICATION

This application is a continuation of International Patent Application No. PCT/CN2023/121906, filed on Sep. 27, 2023, which claims priority to Chinese Patent Application No. 202211221391.0, filed on Oct. 8, 2022. The entire disclosure of both applications is hereby incorporated by reference herein.

### FIELD

The present application relates to the technical field of atomization, and in particular to a porous ceramic body, a method for preparing the porous ceramic body, a heating component, an atomizer, and an electronic atomization device.

### BACKGROUND

An electronic atomization device refers to a device capable of atomizing liquid. Generally, the electronic atomization device includes an atomizer, where the atomizer includes a heating component, the heating component includes a liquid suction element and a heating element positioned on the liquid suction element, and the liquid suction element is mainly a porous ceramic body. In a working process of the electronic atomization device, liquid is sucked into the liquid suction element by the liquid suction element, and is heated by the heating element disposed on the liquid suction element to be atomized.

However, the electronic atomization device in the prior art easily encounters liquid explosion and dry heating, and the user experience is influenced.

### SUMMARY

In an embodiment, the present invention provides a porous ceramic body, wherein a pore size distribution of the porous ceramic body conforms to: d₅₀ is about 5 μm to about 50 μm, and β is about 0.17 to about 0.55, and wherein the β=(d₅₀−d₁₀)/d₅₀.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a process flowchart of a method for preparing a porous ceramic body in some embodiments of the present application.

FIG. 2 is a schematic structural diagram of a heating component in some embodiments of the present application.

FIG. 3 is a schematic structural diagram of an atomizer in some embodiments of the present application.

FIG. 4 is a cross-sectional view of the atomizer shown in FIG. 3.

FIG. 5 is a cross-sectional view of an electronic atomization device including the atomizer shown in FIG. 3.

FIG. 6 is a scanning electron microscope comparison diagram of a commercially available porous ceramic body and a porous ceramic body in Embodiment 1 of the present application.

FIG. 7 is a thermal shock resistance performance result comparison diagram of porous ceramic bodies in Embodiments 1 to 10 of the present application.

FIG. 8 is the atomization efficiency result diagram of an electronic atomization device prepared from the porous ceramic body in Embodiment 13 of the present application.

FIG. 9 is an atomization efficiency result diagram of an electronic atomization device prepared from the porous ceramic body in Embodiment 18 of the present application.

FIG. 10 is a soot condition diagram of a commercially available heating component provided by the present application.

FIG. 11 is a soot condition diagram of a heating component prepared from the porous ceramic body in Embodiment 13 of the present application.

FIG. 12 is a soot condition diagram of a heating component prepared from the porous ceramic body in Embodiment 18 of the present application.

### DETAILED DESCRIPTION

In an embodiment, the present invention provides a porous ceramic body.

In addition, embodiments of the present application further provide a method for preparing the above porous ceramic body, a heating component including the above porous ceramic body, an atomizer including the heating component, and an electronic atomization device including the atomizer.

A porous ceramic body is provided, a material of the porous ceramic body includes one or more of quartz ceramics, cordierite ceramics, and diatomite ceramics, and pores of the porous ceramic body conform to the followings: d₅₀ is about 5 μm to about 50 μm, and β is about 0.17 to about 0.55, where the β=(d₅₀−d₁₀)/d₅₀.

In an embodiment, the porous ceramic body includes one or more of quartz and cordierite.

In an embodiment, the β is about 0.2 to about 0.32.

In an embodiment, the d₅₀ is about 5 μm to about 20 μm.

In an embodiment, the d₅₀ is about 15 μm to about 30 μm.

In an embodiment, the maximum pore size of the porous ceramic body does not exceed about 65 μm, and the most probable pore size of the porous ceramic body does not exceed about 45 μm.

In an embodiment, the porosity of the porous ceramic body is about 3% to about 80%.

In an embodiment, the porosity of the porous ceramic body is about 20% to about 70%.

In an embodiment, the average expansion coefficient of the porous ceramic body under the condition of 800° C. to 1200° C. is about −50 ppm/° C. to about 20 ppm/° C.

In an embodiment, the average expansion coefficient of the porous ceramic body under the condition of 800° C. to 1200° C. is about −30 ppm/° C. to about 20 ppm/° C.

In an embodiment, the compressive strength of the porous ceramic body is greater than about 0.6 Mpa.

In an embodiment, the compressive strength of the porous ceramic body is about 1.5 MPa to about 9 Mpa.

In an embodiment, the porous ceramic body includes about 19 wt % to about 44 wt % of quartz.

In an embodiment, the porous ceramic body further includes at least one of the followings: about 1.3 wt % to about 2.9 wt % of albite, about 0.6 wt % to about 2.4 wt % of aluminum oxide, and about 0.1 wt % to about 0.4 wt % mullite.

In an embodiment, the porous ceramic body further conform tos at least one of the following features: quartz includes at least one of cristobalite and α-quartz; and aluminum oxide includes α-aluminum oxide.

In an embodiment, the porous ceramic body includes about 19 wt % to about 42 wt % of cristobalite and about 0.2 wt % to about 1.7 wt % of α-quartz.

In an embodiment, the porous ceramic body includes about 25 wt % to about 42 wt % of cristobalite, about 2 wt % to about 2.5 wt % of albite, about 0.5 wt % to about 1.5 wt % of α-quartz, about 0.6 wt % to about 2 wt % of α-aluminum oxide, and about 0.1 wt % to about 0.4 wt % of mullite and an amorphous phase material.

In an embodiment, the porous ceramic body includes about 67 wt % to about 88 wt % cordierite.

In an embodiment, the porous ceramic body further includes at least one of the followings: about 2 wt % to about 5 wt % of mullite, about 0 wt % to about 5 wt % of spinel, about 0.8 wt % to about 1 wt % of forsterite, about 0.5 wt % to about 5 wt % of quartz, about 0.3 wt % to about 0.4 wt % of bredigite, about 0.3 wt % to about 0.5 wt % of rutile, and about 5 wt % to about 27 wt % of an amorphous phase material.

In an embodiment, the porous ceramic body includes about 68 wt % to about 85 wt % of cordierite, about 2.5 wt % to about 5 wt % of mullite, about 0.5 wt % to about 1.5 wt % of spinel, about 0.8 wt % to about 1 wt % of forsterite, about 0.8 wt % to about 1.5 wt % of quartz, about 0.3 wt % to about 0.4 wt % of bredigite, about 0.3 wt % to about 0.5 wt % of rutile, and about 6 wt % to about 25 wt % of an amorphous phase material.

A method for preparing the above porous ceramic body includes the following steps:
mixing raw materials for preparing the porous ceramic body to prepare a premix material;
molding the premix material to prepare a green compact; and
sintering the green compact after binder burn out to prepare the porous ceramic body.

In an embodiment, the sintering temperature is about 1000° C. to about 1200° C.

A heating component is provided, and the heating component includes the above porous ceramic body and a heating element positioned on the porous ceramic body.

An atomizer is provided, and includes:
a liquid storage tank for containing liquid; and
the above heating component configured to atomize the liquid in the liquid storage tank.

An electronic atomization device is provided, and includes a power supply and the above atomizer. The power supply is configured to supply electricity to the atomizer.

It should be noted that when one component is expressed as “being connected to” another component, the component may be directly connected to the another component, or one or more intermediate components may exist between the component and the another component. Terms “vertical”, “horizontal”, “left”, “right”, “upper”, “lower”, “inner”, “outer”, “bottom”, etc. indicating the orientation or the positional relationship are based on the orientation or the positional relationship shown in the drawings, are only for convenience of describing the present application, are not intended to indicate or imply that the referenced apparatus or element must have a particular orientation, be constructed and operated in a particular orientation, and therefore cannot be understood as a limitation of the present application. Unless otherwise defined, meanings of all technical and scientific terms used in the present application are the same as those usually understood by a person skilled in the art to which the present application belongs. In the present application, terms used in the specification are merely intended to describe objectives of embodiments of the present application, but are not intended to limit the present application.

In this specification, the porosity and the pore size are measured by a mercury porosity meter, and d₁₀, d₅₀ and doo respectively represent the pore sizes corresponding to the accumulated pore size distribution percentages of 10%, 50% and 90% of a sample, and the d₅₀ is also called as the median pore size or medium pore size.

It is discovered through the research in the present application that the size and the inconsistency of the pore size of the porous ceramic body cause liquid explosion and dry heating in an atomization process. In the atomization process, for the different pore sizes of the porous ceramic body: firstly, the low capillarity pressure of big pores is a root of “liquid leakage”. Then, a large amount of “leaked liquid” having a relatively low temperature and seeping out from the big pores is in contact with an overheated heating element to directly cause “liquid explosion”. Next, in a next high-temperature atomization process, the “big pores” at the low capillarity pressure cannot be filled with liquid because the liquid in the big pores are held by the high capillarity pressure of small pores connected with the big pores, and a “dry heating” phenomenon of the big pores occurs. The “dry heating” phenomenon for a long time has a further manifestation of a great amount of soot (carbon soot) accumulation, and the service life will be influenced. At the same time, the too wide pore size distribution easily causes imbalance between supplied liquid and heat at different powers. For example, at different powers, the atomization temperature of a closed ceramic appliance rises with an increase of the heating power, and the content rise of a harmful and potentially harmful constituents (HPHC) is easily caused, so that the safety risks of users are improved.

Therefore, based on the above, some implementations of the present application provide a porous ceramic body. The pores of the porous ceramic body conforms to the followings: d₅₀ is about 5 μm to about 50 μm, and β is about 0.17 to about 0.55, where the β=(d₅₀−d₁₀)/d₅₀.

The d₅₀ shows the overall distribution condition of the pore sizes of the above porous ceramic body. Optionally, the d₅₀ is 5 μm, 6 μm, 8 μm, 10 μm, 12 μm, 15 μm, 18 μm, 20 μm, 22 μm, 25 μm, 28 μm, 30 μm, 35 μm, 40 μm, 45 μm, or 49 μm. Further, in some embodiments, the d₅₀ is about 5 μm to about 20 μm. In some other embodiments, the d₅₀ is about 15 μm to about 30 μm. In some other embodiments, the d₅₀ is about 15 μm to about 25 μm. Further, the d₅₀ is about 18 μm to about 22 μm.

In some embodiments, the maximum pore size of the above porous ceramic body does not exceed 65 μm; and the most probable pore size of the above porous ceramic body does not exceed 45 μm. In some embodiments, the maximum pore size of the above porous ceramic body is about 38 μm to 62 μm; and the most probable pore size of the above porous ceramic body is about 10 μm to about 22 μm. In some embodiments, the maximum pore size of the above porous ceramic body is about 38 μm to about 45 μm; and the most probable pore size of the above porous ceramic body is about 10 μm to about 22 μm.

The β shows the size distribution consistency condition of the pores of the above porous ceramic body. The smaller β shows the better pore size distribution consistency. Optionally, the β is 0.17, 0.2, 0.25, 0.28, 0.3, 0.35, 0.4, or 0.55. In some embodiments, the β is about 0.17 to about 0.55. Further, the β is about 0.22 to about 0.33. Further, the β is about 0.2 to about 0.32. In some embodiments, the β is about 0.17 to about 0.21.

In some embodiments, the pores of the above porous ceramic body conform to the followings: the d₅₀ is about 15 μm to about 30 μm, and the β is about 0.17 to about 0.55. In some embodiments, the pores of the above porous ceramic body conform to the followings: the d₅₀ is about 18 μm to about 30 μm, and the β is about 0.17 to about 0.33. In some other embodiments, the pores of the above porous ceramic body conform to the followings: the d₅₀ is about 18 μm to about 22 μm, and the β is about 0.17 to about 0.21.

The porosity is used for showing the proportion of the total pore volume of the porous ceramic body in the above porous ceramic body. In some embodiments, the porosity of the above porous ceramic body is about 3% to about 80%. Optionally, the porosity of the above porous ceramic body is 3%, 10%, 20%, 30%, 40%, 45%, 50%, 60%, 70%, and 80%. Further, the porosity of the above porous ceramic body is about 20% to about 70%. Further, the porosity of the above porous ceramic body is about 35% to about 65%.

In some embodiments, the pores of the above porous ceramic body conform to the followings: the d₅₀ is about 15 μm to about 30 μm, the β is about 0.17 to about 0.55, and the porosity is about 5% to about 70%. In some embodiments, the pores of the above porous ceramic body conform to the followings: the d₅₀ is about 18 μm to about 30 μm, the β is about 0.17 to about 0.33, and the porosity is about 35% to about 65%. In some embodiments, the pores of the above porous ceramic body conform to the followings: the d₅₀ is about 18 μm to about 22 μm, the β is about 0.17 to about 0.21, and the porosity is about 45% to about 65%.

In some embodiments, a material of the above porous ceramic body includes one or more of quartz ceramics, cordierite ceramics, and diatomite ceramics. In an optional example, a material of the above porous ceramic body is quartz ceramics, cordierite ceramics, or diatomite ceramics.

In some embodiments, a material of the above porous ceramic body is quartz ceramics. Optionally, the above porous ceramic body includes about 19 wt % to about 44 wt % of quartz. In some examples, the quartz includes at least one of cristobalite and α-quartz. Further, the above porous ceramic body includes about 19 wt % to about 42 wt % of cristobalite and about 0.2 wt % to about 1.7 wt % of α-quartz. Further, the above porous ceramic body further includes at least one of the followings: about 1.3 wt % to about 2.9 wt % albite (NaAlSi₃O₈), about 0.6 wt % to about 2.4 wt % of aluminum oxide, and about 0.1 wt % to about 0.4 wt % mullite (Al₆Si₂O₁₃). In some examples, the above porous ceramic body further includes an amorphous phase material. In some embodiments, the above porous ceramic body includes about 25 wt % to about 42 wt % of cristobalite, about 2 wt % to about 2.5 wt % of albite, about 0.5 wt % to about 1.5 wt % of α-quartz, about 0.6 wt % to about 2 wt % of α-aluminum oxide, and about 0.1 wt % to about 0.4 wt % of mullite and an amorphous phase material. In some embodiments, the above porous ceramic body includes about 25 wt % to about 42 wt % of cristobalite, about 2 wt % to about 2.5 wt % of albite, about 0.5 wt % to about 1.5 wt % of α-quartz, about 0.6 wt % to about 2 wt % of α-aluminum oxide, and about 0.1 wt % to about 0.4 wt % of mullite and the balance of an amorphous phase material.

In some embodiments, a material of the above porous ceramic body is cordierite ceramics. Optionally, the above porous ceramic body includes about 67 wt % to about 88 wt % cordierite (Mg₂Al₄SiO₁₈). Further, the above porous ceramic body further includes at least one of the followings: about 2 wt % to about 5 wt % of mullite, about 0 wt % to about 1.5 wt % of spinel (MgAl₂O₄), about 0.8 wt % to about 1.1 wt % of forsterite (Mg₂SiO₄), about 0.5 wt % to about 1.5 wt % of quartz, about 0.3 wt % to about 0.4 wt % of bredigite (Ca₁₄Mg₂(SiO₄)₈), about 0.3 wt % to about 0.5 wt % of rutile (TiO₂), and about 4 wt % to about 27 wt % of an amorphous phase material. Further, the above porous ceramic body includes about 68 wt % to about 85 wt % of cordierite, about 2.5 wt % to about 5 wt % of mullite, about 0.5 wt % to about 1.5 wt % of spinel, about 0.8 wt % to about 1 wt % of forsterite, about 0.8 wt % to about 1.5 wt % of quartz, about 0.3 wt % to about 0.4 wt % of bredigite, about 0.3 wt % to about 0.5 wt % of rutile, and about 6 wt % to about 25 wt % of an amorphous phase material.

It could be understood that regardless of the preparation of the porous ceramic body from a cordierite ceramic material or the preparation of the porous ceramic body from a quartz ceramic material, the raw material further respectively includes a pore forming material and a necessary molding promoter. Optionally, the pore forming material includes at least one of graphite, amorphous carbon, cellulose, wood flour, nut shell powder, starch, and a synthetic polymer, and the synthetic polymer includes at least one of polyethylene, polystyrene, and polyacrylate. Further, the pore forming material selects at least one of polystyrene microspheres, powdered carbon, flour, and sawdust. Optionally, the particle size of the pore forming material is about 5 μm to about 100 μm. Further, the particle size of the pore forming material is about 5 μm to about 50 μm. Further, the particle size of the pore forming material is about 10 μm to about 40 μm.

In some embodiments, the average expansion coefficient of the above porous ceramic body under the condition of 800° C. to 1200° C. is about −50 ppm/° C. to about 20 ppm/° C. Further, the average expansion coefficient of the above porous ceramic body under the condition of 800° C. to 1200° C. is about −30 ppm/° C. to about 20 ppm/° C.

In some embodiments, the compressive strength of the above porous ceramic body is greater than about 0.6 Mpa. Optionally, the compressive strength of the above porous ceramic body may be, for example, 0.68 MPa, 1 MPa, 1.5 MPa, 2 MPa, 2.5 MPa, 3 MPa, 4 MPa, 4.5 MPa, 5 MPa, 5.5 MPa, 6 MPa, 6.5 MPa, 7 MPa, 8 MPa, 9 MPa, 10 MPa or 11 MPa. Further, in some embodiments, the compressive strength of the above porous ceramic body is about 1.5 MPa to about 9 Mpa. Further, the compressive strength of the above porous ceramic body is about 4 MPa to about 8 Mpa.

In some embodiments, the pores of the above porous ceramic body conform to the followings: d₅₀ is about 15 μm to about 30 μm, β is about 0.17 to about 0.55, the porosity is about 5% to about 70%, the average expansion coefficient under the condition of 800° C. to 1200° C. is about −50 ppm/° C. to about 20 ppm/° C., and the compressive strength is about 0.6 MPa to about 11 MPa. In some embodiments, the pores of the above porous ceramic body conform to the followings: d₅₀ is about 18 μm to about 30 μm, β is about 0.17 to about 0.33, the porosity is about 35% to about 65%, the average expansion coefficient under the condition of 800° C. to 1200° C. is about −30 ppm/° C. to about 20 ppm/° C., and the compressive strength is about 100 N to about 210 N. In some embodiments, the pores of the above porous ceramic body conform to the followings: d₅₀ is about 18 μm to about 22 μm, β is about 0.17 to about 0.21, the porosity is about 45% to about 65%, the average expansion coefficient of the above porous ceramic body under the condition of 800° C. to 1200° C. is about −30 ppm/° C. to about 10 ppm/° C., and the compressive strength is about 0.6 MPa to about 11 MPa.

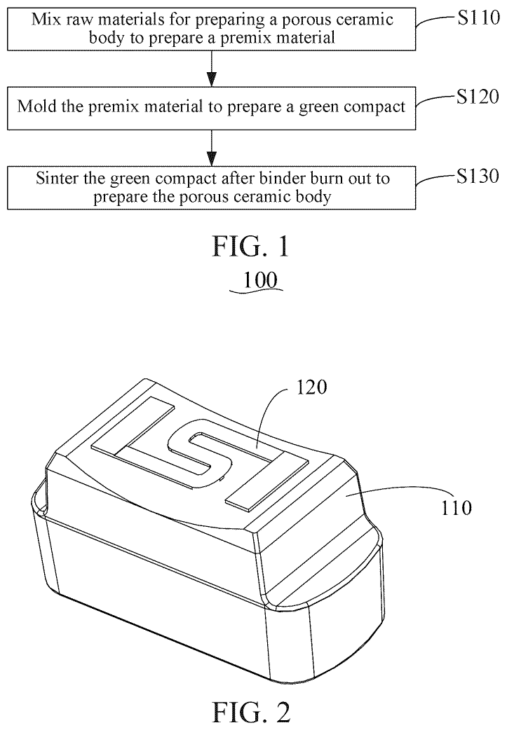

In addition, some implementations of the present application further provide a method for preparing the above porous ceramic body. Referring to FIG. 1, the preparation method includes Step S110, Step S120, and Step S130.

Step S110: Raw materials for preparing a porous ceramic body are mixed to prepare a premix material.

In some embodiments, the raw materials for preparing the porous ceramic body are selected according to the material of the porous ceramic body to be prepared. For example, in a case that the porous ceramic body of a quartz ceramic material or a cordierite ceramic material needs to be prepared, raw materials are correspondingly prepared with reference to the above composition of the porous ceramic body.

In some embodiments, for the porous ceramic body with quartz as a main phase composition, corresponding raw materials may be selected according to the phase composition of the above porous ceramic body. The raw materials mainly include: a silicon dioxide source, an aluminum oxide source, a metal oxide source, a pore forming material, etc.

In some embodiments, the silicon dioxide source is selected from at least one of quartz, cristobalite, zeolite, diatomite, fused silica, colloided silica, amorphous silica, and glass. The median particle size of the silicon dioxide source is about 5 μm to about 100 μm. In some embodiments, the median particle size of the silicon dioxide source is about 15 μm to about 65 μm.

In some embodiments, the aluminum oxide source is selected from at least one of emery, aluminum hydroxide (gibbsite), kaolin, and clay. The median particle size of the aluminum oxide source is about 5 μm to about 100 μm. In some embodiments, the median particle size of the aluminum oxide source is about 15 μm to about 65 μm.

In some embodiments, the metal oxide source is mainly selected from an oxide, a hydroxide, a salt, etc. of a corresponding metallic element. For example, a sodium source is selected from at least one of a sodium-containing salt or alkali such as sodium carbonate, sodium hydroxide, and sodium silicate. A calcium source is selected from at least one of calcium carbonate, calcium hydroxide, barium aluminate, calcium titanate, and calcium silicate. Correspondingly, corresponding salts or oxides of magnesium, aluminum, etc. are also included as raw materials.

In some embodiments, the pore forming material is selected from at least one of graphite, amorphous carbon, cellulose, wood flour, nut shell powder, starch, and a synthetic polymer. The synthetic polymer, for example, is polyethylene, polystyrene, polyacrylate, etc. The median particle size of the pore forming material is about 5 μm to about 100 μm. In some embodiments, the median particle size of the pore forming material is about 15 μm to about 65 μm.

It may be understood that a certain amount of a molding promoter needs to be added in the preparation process. The molding promoter mainly includes at least one of an organic binding agent and an inorganic binding agent, a lubricating agent, and a plasticizer. The molding promoter is selected from at least one of paraffin, stearic acid, methylcellulose, triethanolamine, and water. Further, the molding promoter is selected from at least one of paraffin and stearic acid.

Step S120: The premix material is molded to prepare a green compact.

In some embodiments, a molding manner of the premix material is not limited, and different molding manners may be selected according to the composition of the premix material.

Step S130: The green compact is sintered after binder burn out to prepare the porous ceramic body.

In some embodiments, the sintering temperature is about 1000° C. to about 1200° C. Optionally, the sintering temperature may be, for example, 1000° C., 1050° C., 1100° C., 1150° C., or 1180° C. Further, the sintering temperature is about 1000° C. to about 1150° C.

The method for preparing the above porous ceramic body is simple, and is favorable for mass production.

The above porous ceramic body has the relatively small pore size and good pore size distribution consistency. When being used as a liquid suction element of a heating component in an atomizer, the porous ceramic body may avoid the liquid leakage, liquid explosion and dry heating of the atomizer, and may improve the user experience. Therefore, some implementations of the present application further provide application of the porous ceramic body of any one of the above embodiments to preparation of an electronic atomization device. It may be understood that the application of the above porous ceramic body is not limited to the use as a liquid suction element of a heating component in an electronic atomization device, and the porous ceramic body may further have other applications, and, for example, may be used as a filtering element of a filtering device.

In addition, referring to FIG. 2, some implementations of the present application further provide a heating component 100. The heating component 100 includes a liquid suction element 110 and a heating element 120 positioned on the liquid suction element 110, the liquid suction element 110 is configured to supply liquid to the heating element 120, and the liquid suction element 110 is the porous ceramic body of any one of the above embodiments. In some embodiments, the liquid suction element 110 is in a strip shape, and the heating element 120 is positioned on the end surface of the liquid suction element 110. In this case, liquid flows from one end of the liquid suction element 110 to the other end provided with the heating element 120 to be atomized.

In some other embodiments, the liquid suction element 110 is in a round tubular shape, and the heating element 120 is positioned on the peripheral surface of the round tubular liquid suction element 110. In some other embodiments, the liquid suction element 110 is in a round tubular shape, and the heating element 120 is positioned on the inner side surface of the round tubular liquid suction element 110. In this case, the liquid flows from the outer side surface of the liquid suction element 110 to the hollow inner side surface, and is heated by the heating element 120 to be atomized. In some other embodiments, the heating element 120 is positioned in the liquid suction element 110. In this case, during preparation of the liquid suction element 110, the heating element 120 is pre-embedded in a green compact of the liquid suction element 110 to be sintered together with the green compact. In some other implementations, the heating element 120 may also be disposed on the liquid suction element 110 in a manner of silk-screen or thick film printing, and is sintered and molded.

The above heating component 100 includes the porous ceramic body of any one of the above embodiments, and has corresponding advantages of the above porous ceramic body.

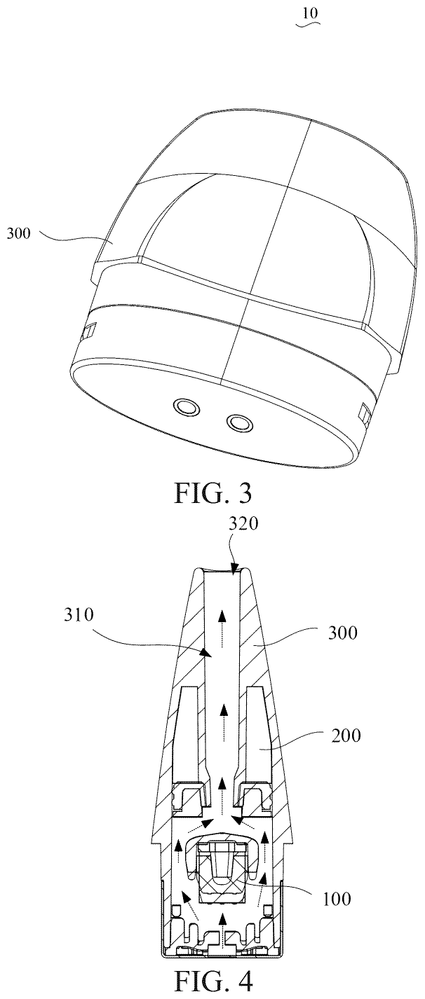

In addition, referring to FIG. 3 and FIG. 4, some implementations of the present application further provide an atomizer 10. The atomizer 10 includes a liquid storage tank 200 and the heating component 100 of any one of the above embodiments. The liquid storage tank 200 is configured to contain a liquid-state atomization material, and the heating component 100 is configured to atomize the atomization material in the liquid storage tank 200. Optionally, the liquid outlet of the liquid storage tank 200 communicates with the liquid inlet of the liquid suction element 110, so that the liquid in the liquid storage tank 200 may flow to the liquid suction element 110 to be atomized by the heating element 120 disposed on the liquid suction element 110. In an embodiment shown in the figures, the atomizer 10 further includes a housing 300. The heating component 100 and the liquid storage tank 200 are positioned in the housing 300. An airflow channel 310 and an air outlet 320 are formed in the housing 300. It should be noted that in FIG. 3, dashed-line arrows indicate the airflow direction in the atomizer 10 during vaping.

The above atomizer 10 includes the heating component 100 of any one of the above embodiments, and has corresponding advantages of the above porous ceramic body.

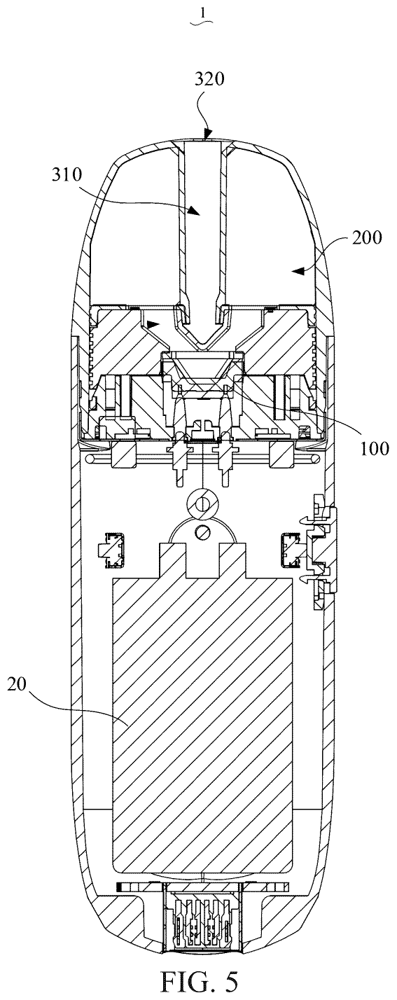

In addition, referring to FIG. 5, some implementations of the present application further provide an electronic atomization device 1, including a power supply 20 and the atomizer 10 in any one of the above embodiments. The power supply 20 is configured to supply electricity to the atomizer 10.

The above electronic atomization device 1 includes the above porous ceramic body of any one of the above embodiments, and has corresponding advantages of the above porous ceramic body.

Detailed descriptions are provided below with reference to specific embodiments. Without special instructions, the following embodiments do not include other components except unavoidable impurities. Reagents and instruments used in embodiments are common choices in the art unless otherwise specified. Experimental methods having specific conditions not indicated in the embodiments are implemented under conventional conditions, such as conditions described in literatures or books or by methods recommended by manufacturers.

1. Corresponding raw materials were prepared according to the porous ceramic body of different composition systems in Table 1 and Table 2. The porous ceramic bodies of Embodiment 1 to Embodiment 40 were quartz porous ceramic bodies, and the porous ceramic bodies of Embodiment 41 to Embodiment 47 were cordierite porous ceramic bodies.

TABLE 1

| | | | | Aluminum | | Amorphous |
|---|---|---|---|---|---|---|
| | Cristobalite | α-quartz | Albite | oxide | Mullite | phase material |
| Embodiment | (wt %) | (wt %) | (wt %) | (wt %) | (wt %) | (wt %) |
| Embodiment 1 | 31 | 0.8 | 2.1 | 1.3 | 0.4 | 64.4 |
| Embodiment 2 | 28 | 0.8 | 2.0 | 1.4 | 0.4 | 67.4 |
| Embodiment 3 | 28 | 0.8 | 1.9 | 1.5 | 0.2 | 67.6 |
| Embodiment 4 | 24 | 0.8 | 1.8 | 1.9 | 0.2 | 71.3 |
| Embodiment 5 | 24 | 0.8 | 1.5 | 1.5 | 0.1 | 72.1 |
| Embodiment 6 | 28 | 0.8 | 2.1 | 1.0 | 0.3 | 67.8 |
| Embodiment 7 | 32 | 0.7 | 1.7 | 0.8 | 0.2 | 64.6 |
| Embodiment 8 | 27 | 0.7 | 1.9 | 0.9 | 0.1 | 69.4 |
| Embodiment 9 | 23 | 0.6 | 1.7 | 1.1 | 0.1 | 73.5 |
| Embodiment 10 | 20 | 0.6 | 1.4 | 0.6 | 0.2 | 77.2 |
| Embodiment 11 | 27 | 1.7 | 1.9 | 1.4 | 0.1 | 67.9 |
| Embodiment 12 | 28 | 0.6 | 1.8 | 1.5 | 0.3 | 67.8 |
| Embodiment 13 | 24 | 0.5 | 1.7 | 1.2 | 0.1 | 72.5 |
| Embodiment 14 | 25 | 0.5 | 1.7 | 1.0 | 0.1 | 71.7 |
| Embodiment 15 | 24 | 0.4 | 1.8 | 0.9 | 0.2 | 72.7 |
| Embodiment 16 | 37 | 0.6 | 1.3 | 2.1 | 0.1 | 58.9 |
| Embodiment 17 | 30 | 0.5 | 2.0 | 2.0 | 0.2 | 65.3 |
| Embodiment 18 | 28 | 0.5 | 1.8 | 2.4 | 0.1 | 67.2 |
| Embodiment 19 | 23 | 0.3 | 1.5 | 1.8 | 0.1 | 73.3 |
| Embodiment 20 | 23 | 0.3 | 2.0 | 1.6 | 0.1 | 73 |
| Embodiment 21 | 39 | 0.6 | 2.6 | 1.0 | 0.1 | 56.7 |
| Embodiment 22 | 39 | 0.5 | 2.9 | 1.2 | 0.3 | 56.1 |
| Embodiment 23 | 32 | 0.6 | 2.8 | 1.1 | 0.2 | 63.3 |
| Embodiment 24 | 31 | 0.4 | 2.1 | 1.0 | 0.1 | 65.4 |
| Embodiment 25 | 28 | 0.5 | 1.9 | 1.0 | 0.3 | 68.3 |
| Embodiment 26 | 35 | 0.5 | 2.3 | 1.5 | 0.3 | 60.4 |
| Embodiment 27 | 33 | 0.5 | 2.3 | 1.5 | 0.1 | 62.6 |
| Embodiment 28 | 30 | 0.5 | 2.2 | 1.1 | 0.1 | 66.1 |
| Embodiment 29 | 25 | 0.4 | 1.9 | 1.5 | 0.1 | 71.1 |
| Embodiment 30 | 23 | 0.4 | 1.6 | 1.0 | 0.1 | 73.9 |
| Embodiment 31 | 33 | 0.4 | 2.3 | 1.3 | 0.2 | 62.8 |
| Embodiment 32 | 32 | 0.5 | 1.9 | 1.1 | 0.1 | 64.4 |
| Embodiment 33 | 30 | 0.4 | 2.0 | 1.2 | 0.1 | 66.3 |
| Embodiment 34 | 24 | 0.4 | 1.7 | 1.3 | 0.1 | 72.5 |
| Embodiment 35 | 23 | 0.3 | 1.5 | 1.1 | 0.1 | 74 |
| Embodiment 36 | 32 | 0.4 | 2.2 | 1.1 | 0.1 | 64.2 |
| Embodiment 37 | 29 | 0.4 | 1.9 | 1.4 | 0.2 | 67.1 |
| Embodiment 38 | 23 | 0.3 | 1.7 | 1.4 | 0.1 | 73.5 |
| Embodiment 39 | 24 | 0.3 | 1.6 | 1.1 | 0.1 | 72.9 |
| Embodiment 40 | 22 | 0.2 | 1.3 | 1.1 | 0.1 | 75.3 |

TABLE 2

| | | | | | | | | Amorphous |
|---|---|---|---|---|---|---|---|---|
| | | | | | | | | phase |
| | Cordierite | Mullite | Spinel | Forsterite | Quartz | Bredigite | Rutile | material |
| Group | (wt %) | (wt %) | (wt %) | (wt %) | (wt %) | (wt %) | (wt %) | (wt %) |
| Embodiment 41 | 67 | 4.6 | 0 | 0.9 | 0.8 | 0.4 | 0.3 | 26 |
| Embodiment 42 | 80 | 3.8 | 0.2 | 0.8 | 0.5 | 0.3 | 0.4 | 14 |
| Embodiment 43 | 81 | 5 | 0.6 | 1.1 | 0.6 | 0.4 | 0.3 | 11 |
| Embodiment 44 | 85.6 | 4.4 | 0.9 | 1.0 | 0.8 | 0.3 | 0.3 | 6.7 |
| Embodiment 45 | 86.1 | 3 | 0.1 | 0.8 | 0.5 | 0.4 | 0.4 | 8.7 |
| Embodiment 46 | 87 | 5 | 1.5 | 0.8 | 0.6 | 0.3 | 0.5 | 4.3 |
| Embodiment 47 | 88 | 4.6 | 0.1 | 0.9 | 1.5 | 0.3 | 0.5 | 4.1 |

### Raw Material Selection:

In the present application, raw materials of the porous ceramic bodies of Embodiment 1 to Embodiment 5 were the same. The raw materials included diatomite, clay, and polystyrene particles. The molding promoter was a mixture of paraffin and stearic acid. The median particle size of the above raw materials was 5 μm. The proportion of the pore forming material was 60 wt %.

In the present application, raw materials of the porous ceramic bodies of Embodiment 6 to Embodiment 10 were the same. The raw materials included diatomite, clay, and polystyrene particles. The molding promoter was a mixture of paraffin and stearic acid. The median particle size of the above raw materials was 15 μm. The proportion of the pore forming material was 60 wt %.

In the present application, raw materials of the porous ceramic bodies of Embodiment 11 to Embodiment 15 were the same. The raw materials included diatomite, clay, and polystyrene particles. The molding promoter was a mixture of paraffin and stearic acid. The median particle size of the above raw materials was 30 μm. The proportion of the pore forming material was 50 wt %.

In the present application, raw materials of the porous ceramic bodies of Embodiment 16 to Embodiment 20 were the same. The raw materials included diatomite, clay, and polystyrene particles. The molding promoter was a mixture of paraffin and stearic acid. The median particle size of the above raw materials was 65 μm. The proportion of the pore forming material was 50 wt %.

In the present application, raw materials of the porous ceramic bodies of Embodiment 21 to Embodiment 25 were the same. The raw materials included diatomite, glass, and polystyrene particles. The molding promoter was a mixture of paraffin and stearic acid. The median particle size of the above raw materials was 5 μm. The proportion of the pore forming material was 60 wt %.

In the present application, raw materials of the porous ceramic bodies of Embodiment 26 to Embodiment 30 were the same. The raw materials included diatomite, glass, and polystyrene particles. The molding promoter was a mixture of paraffin and stearic acid. The median particle size of the above raw materials was 15 μm. The proportion of the pore forming material was 60 wt %.

In the present application, raw materials of the porous ceramic bodies of Embodiment 31 to Embodiment 35 were the same. The raw materials included diatomite, glass, and polystyrene particles. The molding promoter was a mixture of paraffin and stearic acid. The median particle size of the above raw materials was 30 μm. The proportion of the pore forming material was 50 wt %.

In the present application, raw materials of the porous ceramic bodies of Embodiment 36 to Embodiment 40 were the same. The raw materials included diatomite, glass, and polystyrene particles. The molding promoter was a mixture of paraffin and stearic acid. The median particle size of the above raw materials was 65 μm. The proportion of the pore forming material was 50 wt %.

As shown in Table 2, the porous ceramic bodies of Embodiment 41 to Embodiment 47 were made of cordierite ceramics. Referring to Embodiment 1 to Embodiment 40, raw materials of corresponding compositions were selected. Generally, the raw materials may be selected from at least one of magnesium oxide (MgO) power, aluminum oxide (Al₂O₃) powder and silicon dioxide (SiO₂) powder, etc.

### 2. Preparation:

As described above, the raw materials of each of the porous ceramic bodies were mixed to prepare grouped premix materials, and then, each of the premix materials was respectively molded and subjected to binder burn out, and was then sintered under the conditions of 1000° C., 1050° C., 1100° C., 1150° C., and 1200° C., to obtain a plurality of porous ceramic bodies.

### 3. Testing:

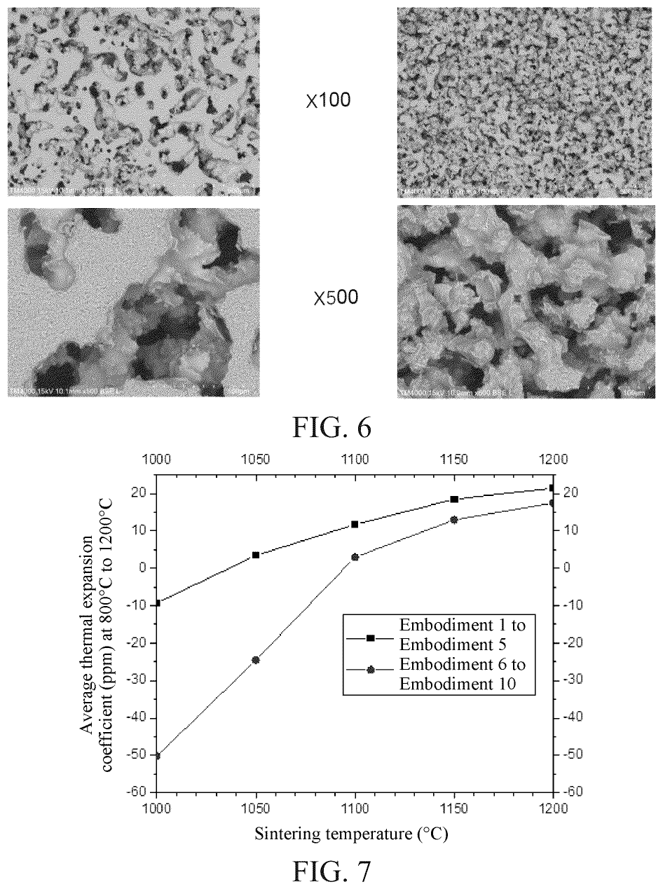

(1) According to a mercury intrusion method, the pore size and the porosity of each porous ceramic body were measured by using a mercury porometer, internal structures of the porous ceramic bodies were observed by using a scanning electron microscope, and some results were as shown in Table 3 and FIG. 6. The phase composition of each porous ceramic body was analyzed by XRD, results thereof were as shown in Table 1 and Table 2.

TABLE 3

| | | | | Most | | | |
|---|---|---|---|---|---|---|---|
| | Sintering | | Average | probable | | | |
| | temperature | Porosity | pore size | pore size | d₅₀ | d₁₀ | |
| Embodiment | (° C.) | (%) | (μm) | (μm) | (μm) | (μm) | β |
| 1 | 1000 | 63.27 | 16.17 | 19.76 | 19.47 | 10.30 | 0.47 |
| 2 | 1050 | 63.11 | 16.37 | 21.90 | 20.74 | 11.09 | 0.47 |
| 3 | 1100 | 66.76 | 18.03 | 21.14 | 20.81 | 13.17 | 0.37 |
| 4 | 1150 | 63.40 | 16.74 | 22.76 | 20.60 | 10.92 | 0.47 |
| 5 | 1200 | 53.41 | 18.94 | 21.82 | 21.14 | 15.07 | 0.29 |
| 6 | 1000 | 65.59 | 19.39 | 23.05 | 22.65 | 13.92 | 0.39 |
| 7 | 1050 | 63.17 | 18.87 | 23.88 | 22.65 | 11.38 | 0.50 |
| 8 | 1100 | 65.14 | 18.38 | 23.47 | 22.77 | 11.14 | 0.51 |
| 9 | 1150 | 54.21 | 20.91 | 24.17 | 23.47 | 14.79 | 0.37 |
| 10 | 1200 | 43.91 | 20.45 | 23.31 | 21.84 | 16.24 | 0.26 |
| 11 | 1000 | 60.28 | 22.11 | 24.29 | 24.88 | 15.02 | 0.40 |
| 12 | 1050 | 62.25 | 25.32 | 26.81 | 26.81 | 17.14 | 0.36 |
| 13 | 1100 | 56.55 | 27.91 | 26.37 | 27.20 | 18.89 | 0.31 |
| 14 | 1150 | 36.12 | 21.90 | 22.92 | 22.92 | 16.17 | 0.29 |
| 15 | 1200 | 3.84 | 17.64 | 17.93 | 18.43 | 13.16 | 0.29 |
| 16 | 1000 | 50.76 | 31.71 | 28.56 | 29.31 | 21.77 | 0.26 |
| 17 | 1050 | 43.82 | 26.97 | 27.57 | 28.36 | 20.65 | 0.27 |
| 18 | 1100 | 40.93 | 27.81 | 28.02 | 28.02 | 21.92 | 0.22 |
| 19 | 1150 | 3.49 | 19.57 | 21.51 | 21.11 | 14.95 | 0.29 |
| 20 | 1200 | — | — | — | — | — | — |
| 21 | 1000 | 75.42 | 20.85 | 26.21 | 25.14 | 14.42 | 0.43 |
| 22 | 1050 | 64.06 | 20.96 | 24.87 | 24.47 | 15.55 | 0.36 |
| 23 | 1100 | 61.31 | 21.04 | 24.87 | 24.47 | 12.87 | 0.47 |
| 24 | 1150 | 58.11 | 20.50 | 23.76 | 23.23 | 13.76 | 0.41 |
| 25 | 1200 | 57.69 | 20.76 | 23.40 | 21.87 | 16.29 | 0.26 |
| 26 | 1000 | 63.34 | 22.83 | 27.21 | 27.21 | 15.93 | 0.41 |
| 27 | 1050 | 61.40 | 23.00 | 27.21 | 27.21 | 14.16 | 0.48 |
| 28 | 1100 | 61.32 | 22.26 | 27.90 | 27.33 | 15.69 | 0.43 |
| 29 | 1150 | 47.79 | 24.03 | 26.48 | 25.96 | 18.60 | 0.28 |
| 30 | 1200 | 24.32 | 21.06 | 22.29 | 22.29 | 16.19 | 0.27 |
| 31 | 1000 | 63.40 | 28.05 | 34.21 | 33.25 | 17.06 | 0.49 |
| 32 | 1050 | 58.25 | 29.39 | 33.18 | 32.35 | 22.02 | 0.32 |
| 33 | 1100 | 53.33 | 28.00 | 32.72 | 32.08 | 22.29 | 0.31 |
| 34 | 1150 | 34.87 | 26.87 | 30.40 | 28.82 | 20.67 | 0.28 |
| 35 | 1200 | — | — | — | — | — | — |
| 36 | 1000 | 53.88 | 43.52 | 43.60 | 46.74 | 34.15 | 0.27 |
| 37 | 1050 | 46.32 | 40.94 | 43.54 | 42.29 | 32.04 | 0.24 |
| 38 | 1100 | 21.67 | 35.44 | 34.56 | 35.56 | 28.56 | 0.20 |
| 39 | 1150 | — | — | — | — | — | — |
| 40 | 1200 | — | — | — | — | — | — |

In FIG. 6, the left side shows scanning electron microscopy diagrams of a commercially available product (for comparison), and the right side shows scanning electron microscopy diagrams of Embodiment 1.

It can be seen from FIG. 6 that the pore size of the porous ceramic body of the present application was more uniform.

(2) The thermal impact resistance performance of each porous ceramic body was tested, and some results were shown in FIG. 7.

It can be known from FIG. 7 that the porous ceramic bodies of Embodiment 1 to Embodiment 5 and Embodiment 6 to Embodiment 10 had good thermal impact resistance performance. It can be known that the porous ceramic body of the present application had good thermal impact resistance performance. When applied to a heating component of an atomizer, the porous ceramic body might significantly improve the service life of the heating component. The reason was that in some implementations, preset patterns were formed by heating circuits in a silk-screen or thick film printing manner, and molding was performed in a sintering manner. A conventional porous ceramic body had a poor thermal impact resistance effect. In a thermal impact process, a heating circuit might be easily damaged. However, the heating component in the embodiment used the porous ceramic body of the present embodiment, had good thermal impact resistance performance, and was able to avoid heating circuit damage in the thermal impact process.

(3) Mechanical properties of the porous ceramic bodies were tested, and some results were as shown in Table 4.

TABLE 4

| | Sintering | Compressive |
|---|---|---|
| | temperature | strength |
| Group | (° C.) | (MPa) |
| Embodiment 1 | 1000 | 0.68 |
| Embodiment 2 | 1050 | 1.10 |
| Embodiment 3 | 1100 | 1.53 |
| Embodiment 4 | 1150 | 2.95 |
| Embodiment 5 | 1200 | 4.53 |
| Embodiment 6 | 1000 | 2.76 |
| Embodiment 7 | 1050 | 3.48 |
| Embodiment 8 | 1100 | 3.79 |
| Embodiment 9 | 1150 | 4.90 |
| Embodiment 10 | 1200 | 6.36 |
| Embodiment 11 | 1000 | 4.03 |
| Embodiment 12 | 1050 | 4.63 |
| Embodiment 13 | 1100 | 5.16 |
| Embodiment 14 | 1150 | 6.29 |
| Embodiment 15 | 1200 | 8.28 |
| Embodiment 16 | 1000 | 5.78 |
| Embodiment 17 | 1050 | 6.24 |
| Embodiment 18 | 1100 | 6.56 |
| Embodiment 19 | 1150 | 9.17 |
| Embodiment 20 | 1200 | 9.52 |
| Embodiment 21 | 1000 | 1.58 |
| Embodiment 22 | 1050 | 2.38 |
| Embodiment 23 | 1100 | 3.60 |
| Embodiment 24 | 1150 | 5.31 |
| Embodiment 25 | 1200 | 6.29 |
| Embodiment 26 | 1000 | 2.93 |
| Embodiment 27 | 1050 | 3.89 |
| Embodiment 28 | 1100 | 4.65 |
| Embodiment 29 | 1150 | 5.42 |
| Embodiment 30 | 1200 | 8.25 |
| Embodiment 31 | 1000 | 3.86 |
| Embodiment 32 | 1050 | 4.46 |
| Embodiment 33 | 1100 | 5.63 |
| Embodiment 34 | 1150 | 7.39 |
| Embodiment 35 | 1200 | 9.45 |
| Embodiment 36 | 1000 | 5.30 |
| Embodiment 37 | 1050 | 6.64 |
| Embodiment 38 | 1100 | 8.69 |
| Embodiment 39 | 1150 | 10.40 |
| Embodiment 40 | 1200 | 10.52 |

It can be seen from comparison between Embodiment 11 to Embodiment 14 and Embodiment 16 to Embodiment 18 in Table 3 and Table 4 that under the condition that the porosity of the porous ceramic bodies of Embodiment 11 to Embodiment 14 was higher than the porosity of the porous ceramic bodies of Embodiment 16 to Embodiment 18, the compressive strengths did not have too great differences. Therefore, the porous ceramic body provided in the present application has high mechanical strength, and when applied to the heating component of the atomizer, the porous ceramic body can significantly prolong the service life of the heating component.

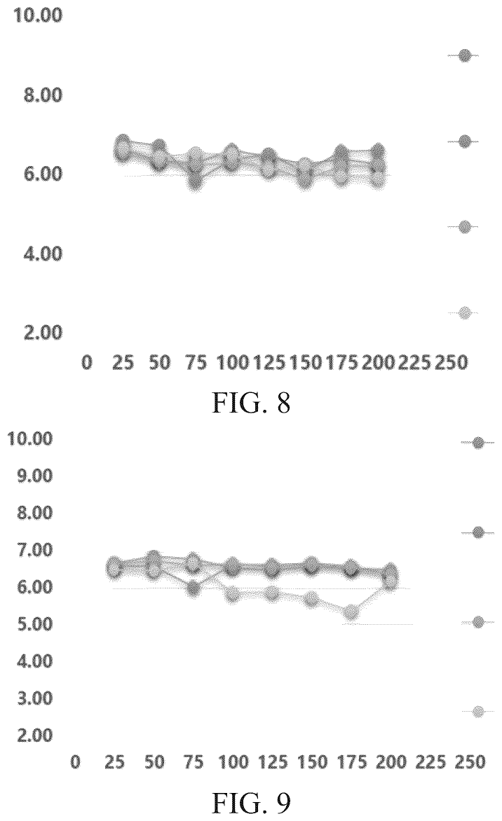

(4) The atomization efficiency (6 W) and the carbon soot formation condition of each porous ceramic body were tested, and some results were as shown in FIG. 8 to FIG. 12. In the figures:

FIG. 8 is an atomization efficiency result diagram of an electronic atomization device prepared from the porous ceramic body in Embodiment 13. Through the test, the average atomization efficiency (n=4) of the electronic atomization device was 6.35 mg/puff. FIG. 9 is an atomization efficiency result diagram of an electronic atomization device prepared from the porous ceramic body in Embodiment 18. In FIG. 8 and FIG. 9, a horizontal coordinate represents the number of vaping puffs, and a vertical coordinate represents the vapor amount. Through the test, the average atomization efficiency (n=4) of the electronic atomization device in Embodiment 18 was 6.44 mg/puff. Meanwhile, under same test conditions, a test result of a commercially available heating component (for comparison) was 5.36 mg/puff.

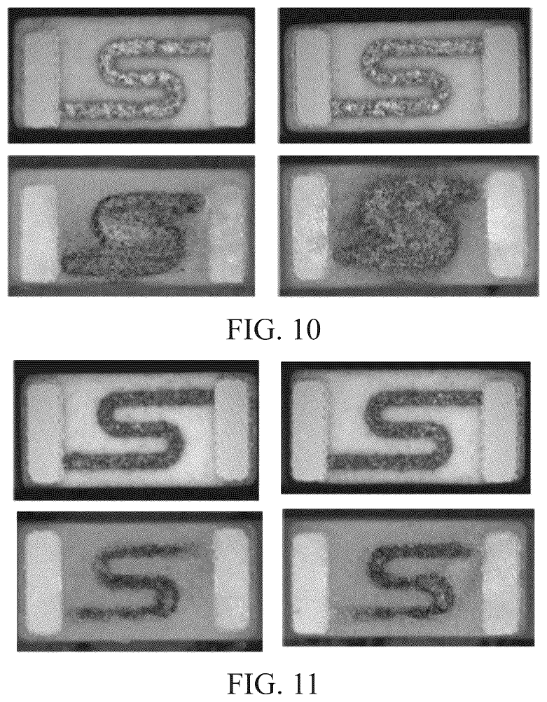

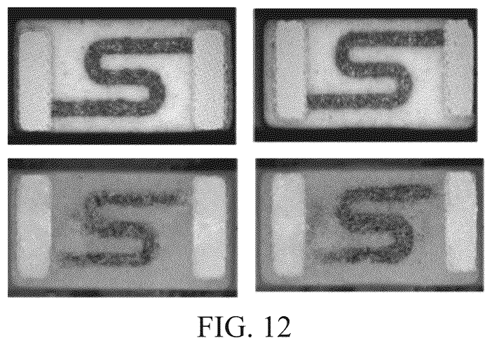

FIG. 10 is a soot condition diagram of a commercially available heating component (for comparison), and the maximum number of vaping puffs is 200 puffs. FIG. 11 is a soot condition diagram of a heating component prepared from the porous ceramic body in Embodiment 13, and the maximum number of vaping puffs is 200 puffs. FIG. 12 is a soot condition diagram of the heating component prepared from the porous ceramic body in Embodiment 18, and the maximum number of vaping puffs is 200 puffs.

In FIG. 10 to FIG. 12, upper pictures are states before vaping, and lower pictures are states after a vaping test for 200 puffs. It may be seen that the carbon accumulation of the heating component of embodiments of the present application is less than that of a comparative example.

From FIG. 8 to FIG. 12, it can be seen that the atomization efficiency of the heating component prepared from the porous ceramic body having the uniform pore size and the high porosity is improved by 18% to 20%, the atomization efficiency is better, and less carbon soot is generated and the service life is prolonged.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A porous ceramic body, wherein a pore size distribution of the porous ceramic body conforms to: d₅₀ is about 5 μm to about 50 μm, and β is about 0.17 to about 0.55, and wherein the β=(d₅₀−d₁₀)/d₅₀.

2. The porous ceramic body of claim 1, wherein the porous ceramic body comprises at least one of quartz and cordierite.

3. The porous ceramic body of claim 1, wherein β is about 0.2 to about 0.32.

4. The porous ceramic body of claim 1, wherein d₅₀ is about 5 μm to about 20 μm.

5. The porous ceramic body of claim 1, wherein d₅₀ is about 15 μm to about 30 μm.

6. The porous ceramic body of claim 1, wherein a maximum pore size of the porous ceramic body does not exceed about 65 μm, and
wherein a most probable pore size of the porous ceramic body does not exceed about 45 μm.

7. The porous ceramic body of claim 1, wherein a porosity of the porous ceramic body is about 3% to about 80%.

8. The porous ceramic body of claim 7, wherein the porosity of the porous ceramic body is about 20% to about 70%.

9. The porous ceramic body of claim 1, wherein an average expansion coefficient of the porous ceramic body from 800° C. to 1200° C. is about −50 ppm/° C. to about 20 ppm/° C.

10. The porous ceramic body of claim 9, wherein the average expansion coefficient of the porous ceramic body from 800° C. to 1200° C. is about −30 ppm/° C. to about 20 ppm/° C.

11. The porous ceramic body of claim 1, wherein a compressive strength of the porous ceramic body is greater than about 0.6 Mpa.

12. The porous ceramic body of claim 11, wherein the compressive strength of the porous ceramic body is about 1.5 MPa to about 9 Mpa.

13. The porous ceramic body claim 1, wherein the porous ceramic body comprises about 19 wt % to about 44 wt % of quartz.

14. The porous ceramic body of claim 13, wherein the porous ceramic body comprises at least one:
about 1.3 wt % to about 2.9 wt % of albite,
about 0.6 wt % to about 2.4 wt % of aluminum oxide, and
about 0.1 wt % to about 0.4 wt % mullite.

15. The porous ceramic body of claim 14, wherein the quartz comprises at least one of cristobalite and α-quartz, and
wherein the aluminum oxide comprises α-aluminum oxide.

16. The porous ceramic body of claim 15, wherein the porous ceramic body comprises about 19 wt % to about 42 wt % of cristobalite and about 0.2 wt % to about 1.7 wt % of α-quartz.

17. The porous ceramic body of claim 1, wherein the porous ceramic body comprises about 25 wt % to about 42 wt % of cristobalite, about 2 wt % to about 2.5 wt % of albite, about 0.5 wt % to about 1.5 wt % of α-quartz, about 0.6 wt % to about 2 wt % of α-aluminum oxide, about 0.1 wt % to about 0.4 wt % of mullite, and an amorphous phase material.

18. The porous ceramic body of claim 1, wherein the porous ceramic body comprises about 67 wt % to about 88 wt % cordierite.

19. The porous ceramic body of claim 18, wherein the porous ceramic body comprises at least one of:
about 2 wt % to about 5 wt % of mullite,
about 0 wt % to about 1.5 wt % of spinel,
about 0.8 wt % to about 1.1 wt % of forsterite,
about 0.5 wt % to about 1.5 wt % of quartz,
about 0.3 wt % to about 0.4 wt % of bredigite,
about 0.3 wt % to about 0.5 wt % of rutile, and
about 5 wt % to about 27 wt % of an amorphous phase material.

20. The porous ceramic body of claim 19, wherein the porous ceramic body comprises about 68 wt % to about 85 wt % of cordierite, about 2.5 wt % to about 5 wt % of mullite, about 0.5 wt % to about 1.5 wt % of spinel, about 0.8 wt % to about 1 wt % of forsterite, about 0.8 wt % to about 1.5 wt % of quartz, about 0.3 wt % to about 0.4 wt % of bredigite, about 0.3 wt % to about 0.5 wt % of rutile, and about 6 wt % to about 25 wt % of an amorphous phase material.

21. A method for preparing the porous ceramic body of claim 1, the method comprising:
mixing raw materials for preparing the porous ceramic body to prepare a premix material;
molding the premix material to prepare a green compact; and
sintering the green compact after binder burn out to prepare the porous ceramic body.

22. The method of claim 21, wherein a sintering temperature of the sintering is about 1000° C. to about 1200° C.

23. A heating component, comprising:
the porous ceramic body of claim 1; and
a heating element positioned on the porous ceramic body.

24. An atomizer, comprising:
a liquid storage tank configured to contain liquid; and
the heating component of claim 23, the heating component being configured to atomize liquid in the liquid storage tank.

25. An electronic atomization device, comprising:
a power supply; and
the atomizer of claim 24,
wherein the power supply is configured to supply electricity to the atomizer.
